(19) United States
(12) Patent Application Publication
(10) Pub. No.: US 2016/0227500 A1
(43) Pub. Date: Aug. 4, 2016

(54) EFFICIENT METHOD TO PERFORM ACQUISITION ON GSM SUBSCRIPTION IN MULTI-SUBSCRIBER IDENTITY MODULE DEVICE

(71) Applicant: QUALCOMM Incorporated, San Diego, CA (US)

(72) Inventors: Surendra Kompala, Hyderabad (IN); Venkata Raji Reddy Kanthala, Hyderabad (IN)

(21) Appl. No.: 14/611,044

(22) Filed: Jan. 30, 2015

(51) Int. Cl. H04W 56/00; H04W 72/04

(52) U.S. Cl. CPC H04W 56/0005; H04W 72/0406

(57) ABSTRACT

A method includes: decoding frequency correction channel (FCCH) data and synchronization channel (SCH) data transmitted by a first base transceiver station (BTS) to obtain a first set of synchronization information; determining whether broadcast control channel (BCCH) data transmitted by the first BTS was successfully decoded using the first set of synchronization information; and in response to a determination that the BCCH data transmitted by the first BTS was not successfully decoded using the first set of synchronization information: determining a cause of a BCCH decoding failure; and in response to a determination that the cause of the BCCH decoding failure is stale synchronization information in the first set of synchronization information, repeating a decoding of the FCCH data and the SCH data transmitted by the first BTS to obtain a second set of synchronization information.

### BACKGROUND

In a Global System for Mobile Communications (GSM) network, the identity, configuration, and capabilities of a base transceiver station (BTS) may be conveyed to a mobile communication device in various types of system information (SI) messages. For example, one type of SI message may provide the absolute radio frequency channel number (ARFCN) and random access channel (RACH) parameters of the BTS. A mobile communication device may decode SI messages before the mobile communication device is able to acquire a communication network (e.g., a public land mobile network (PLMN)) and camp on a BTS.

SI messages may be transmitted on the broadcast control channel (BCCH). The BCCH is a logical channel that is broadcast by the BTS using the same frequency (e.g., beacon frequency) as other control channels including, for example, but not limited to, the frequency correction channel (FCCH), synchronization channel (SCH), and common control channel (CCCH). Data bursts that correspond to different control channels may be transmitted according to a predetermined scheduling pattern. In order to decode BCCH data (e.g., SI messages), the mobile communication device may require information from the FCCH and SCH to synchronize to the frequency and timing of BTS. Thus, the mobile communication device may need to decode the FCCH and SCH data broadcast by a BTS before decoding BCCH data.

However, in a conventional multi subscriber identity module (SIM) mobile communication device having a shared radio frequency (RF) chain, BCCH decoding on the GSM subscription may not always take place immediately after FCCH and SCH decoding. Instead, after FCCH and SCH data is decoded to obtain synchronization information, BCCH decoding may be postponed while one of the other subscriptions utilizes the RF chain to perform a higher priority activity (e.g., voice call, short message service (SMS)). When the GSM subscription regains the RF chain, the synchronization information obtained earlier may have become stale and BCCH decoding may fail using the stale synchronization information. The GSM subscription may consequently be unable to acquire a communication network and camp on a corresponding BTS. As a result, the GSM subscription may remain in an out of service (OOS) state for a prolonged period of time.

### SUMMARY

Apparatuses and methods for efficiently performing acquisition on a GSM subscription in multi-SIM devices are provided.

According to the various embodiments, there is provided a method. The method may include: decoding FCCH data and SCH data transmitted by a first BTS to obtain a first set of synchronization information; determining whether BCCH data transmitted by the first BTS was successfully decoded using the first set of synchronization information; and in response to a determination that the BCCH data transmitted by the first BTS was not successfully decoded using the first set of synchronization information: determining a cause of a BCCH decoding failure; and in response to a determination that the cause of the BCCH decoding failure is stale synchronization information in the first set of synchronization information, repeating a decoding of the FCCH data and the SCH data transmitted by the first BTS to obtain a second set of synchronization information.

According to the various embodiments, there is provided a mobile communication device. In some embodiments, the mobile communication device may include a control unit and an RF chain.

The control unit may be configured to: decode FCCH data and SCH data transmitted by a first BTS to obtain a first set of synchronization information; determine whether BCCH data transmitted by the first BTS was successfully decoded using the first set of synchronization information; and in response to a determination that the BCCH data transmitted by the first BTS was not successfully decoded using the first set of synchronization information: determine a cause of a BCCH decoding failure; and in response to a determination that the cause of the BCCH decoding failure is stale synchronization information in the first set of synchronization information, repeat a decoding of the FCCH data and the SCH data transmitted by the first BTS to obtain a second set of synchronization information.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a diagram illustrating a network environment for various embodiments;

FIG. 2 is a block diagram illustrating a mobile communication device according to various embodiments;

FIG. 3 is a flowchart illustrating a process for optimizing an acquisition of a communication network on a GSM subscription according to various embodiments;

FIG. 4A is a flowchart illustrating a process for determining a cause of BCCH decoding failure according to various embodiments;

FIG. 4B is a flowchart illustrating a process for determining a cause of BCCH decoding failure according to various embodiments; and

FIG. 5 is a flowchart illustrating a process for determining a cause of BCCH decoding failure according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

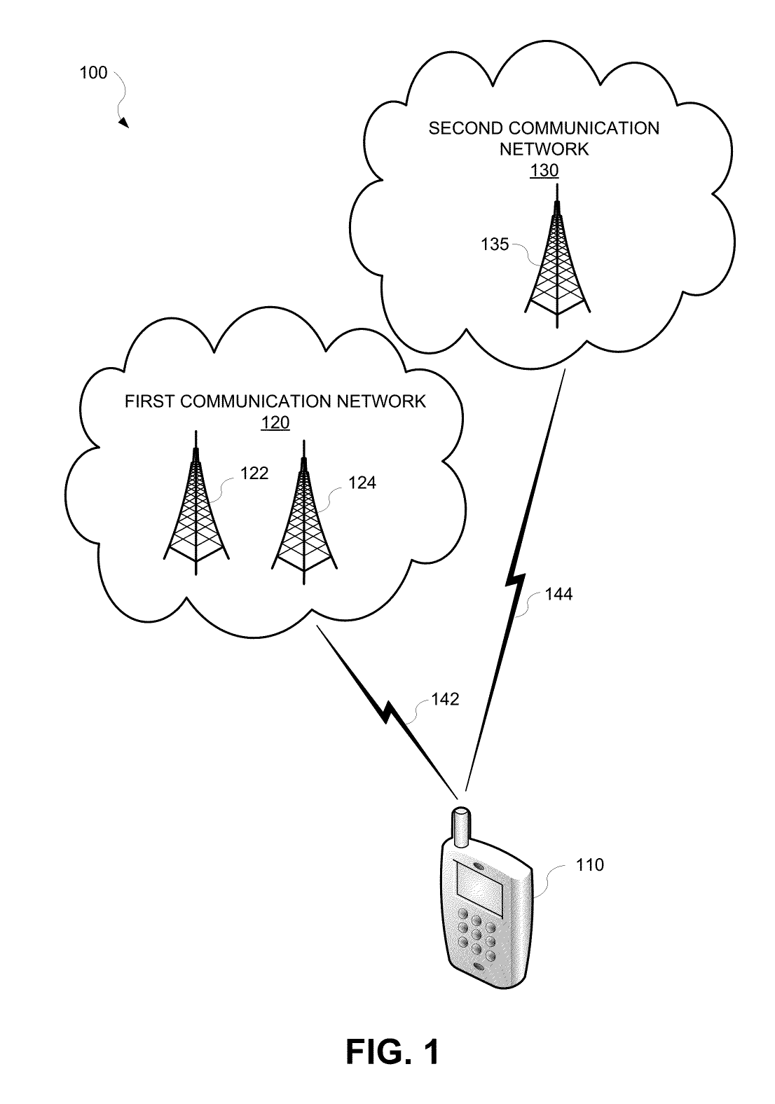

FIG. 1 is a diagram illustrating a network environment 100 for various embodiments. Referring to FIG. 1, a mobile communication device 110 may communicate with a first communication network 120 using a first subscription 142.

In various embodiments, the mobile communication device 110 may be a multi-SIM mobile communication device. Thus, in addition to the first communication network 120, the mobile communication device 110 may communicate with at least one other communication network. For example, the mobile communication device 110 may communicate with a second communication network 130 using a second subscription 144. In various embodiments, the first communication network 120 and the second communication network 130 may each be, for example, but not limited to, a wireless or mobile communication network.

The first communication network 120 and the second communication network 130 may implement the same or different radio access technologies (RATs). For example, the first communication network 120 may be a GSM network and the first subscription 142 may be a GSM subscription. The second communication network 130 may also be a GSM network. Alternately, the second communication network 130 may implement another RAT including, for example, but not limited to, Long Term Evolution (LTE), Wideband Code Division Multiple Access (WCDMA), and Time Division-Synchronous Code Division Multiple Access (TD-SCDMA).

The first communication network 120 may include a plurality of BTSs including, for example, but not limited to, a first BTS 122 and a second BTS 124. The second communication network 130 may also include a plurality of BTSs, including, for example, but not limited to, a third BTS 135. A person having ordinary skill in the art can appreciate that the network environment 100 may include any number of communication networks, mobile communication devices, and BTSs without departing from the scope of the present inventive concept.

The mobile communication device 110 may attempt to acquire the first communication network 120 and camp on the first BTS 122. To acquire the first communication network 120, the mobile communication device 110 may decode data broadcast by the first BTS 122 on the FCCH and the SCH. For example, the data that is broadcast on the FCCH may include a frequency offset between the mobile communication device 110 and the first BTS 122. Meanwhile, the data that is broadcast on the SCH may include a current frame clock and a base station identity code (BSIC) of the first BTS 122.

The mobile communication device 110 may rely on data from the FCCH and SCH to synchronize to the frequency and timing of the first BTS 122. Once the mobile communication device 110 is synchronized to the frequency and timing of the first BTS 122, the mobile communication device 110 may decode data broadcast by the first BTS 122 on the BCCH. For example, the first BTS 122 may broadcast one or more SI messages that may inform the mobile communication device 110 whether the mobile communication device 110 may camp on the first BTS 122. The mobile communication device 110 may decode data transmitted by the first BTS 122 on the BCCH in order to complete acquisition of the first communication network 120 and camp on the first BTS 122.

The mobile communication device 110 may also attempt to acquire the second communication network 130 and camp on the third BTS 135. A person having ordinary skill in the art can appreciate that the acquisition of the first communication network 120 performed on the first subscription 142 may be independent of the acquisition of the second communication network 130 performed on the second subscription 144. Furthermore, the mobile communication device 110 may attempt to acquire the first communication network 120 on the first subscription 142 and the second communication network 130 on the second subscription 144 in the same or a different manner.

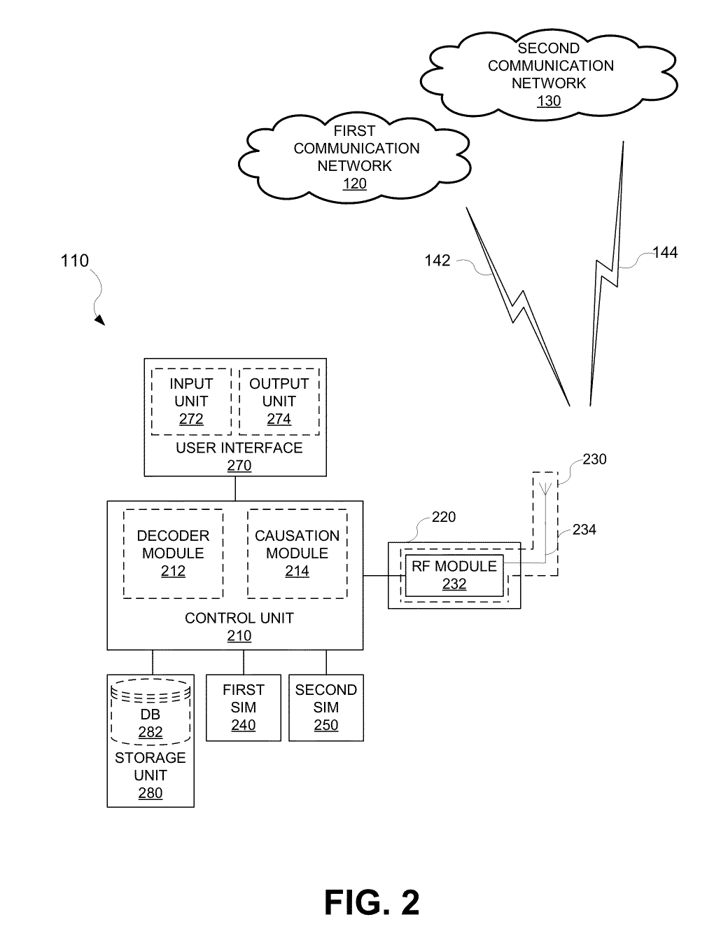

FIG. 2 is a block diagram illustrating the mobile communication device 110 according to various embodiments. Referring to FIGS. 1 and 2, in various embodiments, the mobile communication device 110 may include a control unit 210, a communication unit 220, a first SIM 240, a second SIM 250, a user interface 270, and a storage unit 280.

In various embodiments, the mobile communication device 110 may be any device capable of wirelessly communicating with one or more communication networks. In various embodiments, the mobile communication device 110 may be, for example, but not limited to, a smartphone, a tablet PC, or a laptop computer.

In various embodiments, the communication unit 220 may include an RF chain 230. The RF chain 230 may include, for example, but not limited to, an RF module 232 and an antenna 234. Although the mobile communication device 110 is shown to include the communication unit 220, a person having ordinary skill in the art can appreciate that the mobile communication device 110 may include additional communication units without departing from the scope of the present inventive concept.

In various embodiments, the first SIM 240 may associate the communication unit 220 with the first subscription 142 on the first communication network 120 while the second SIM 250 may associate the communication unit 220 with the second subscription 144 on the second communication network 130.

In various embodiments, the first communication network 120 and the second communication network 130 may be operated by the same or different service providers. Additionally, in various embodiments, the first communication network 120 and the second communication network 130 may each support the same or different RATs, including, for example, but not limited to LTE, GSM, CDMA, and TD-SCDMA.

In various embodiments, the user interface 270 may include an input unit 272. In some embodiments, the input unit 272 may be, for example, but not limited to, a keyboard or a touch panel. In various embodiments, the user interface 270 may include an output unit 274. In some embodiments, the output unit 274 may be, for example, but not limited to, a liquid crystal display (LCD) or a light emitting diode (LED) display. A person having ordinary skill in the art will appreciate that other types or forms of input and output units may be used without departing from the scope of the present inventive concept.

In various embodiments, the control unit 210 may be configured to control the overall operation of the mobile communication device 110 including controlling the functions of the communication unit 220. In various embodiments, the control unit 210 may include a decoder module 212 and a causation module 214. In various embodiments, the control unit 210 may be, for example, but not limited to, a microprocessor (e.g., general-purpose processor, baseband modem processor, etc.) or a microcontroller.

In various embodiments, the storage unit 280 may be configured to store application programs, application data, and user data. In various embodiments, the storage unit 280 may include a database 282 that is configured to store data indicating one or more BTSs on which the control unit 210 may have previously attempted to acquire a selected communication network (e.g., the first communication network 120 or the second communication network 130) on a corresponding subscription (e.g., the first subscription 142 or the second subscription 144). Furthermore, in various embodiments, at least some of the application programs stored at the storage unit 280 may be executed by the control unit 210 for the operation of the mobile communication device 110.

In various embodiments, the control unit 210 may attempt to acquire the first communication network 120 on the first subscription 142 and camp on the first BTS 122. The control unit 210 may decode FCCH and SCH data on the first subscription 142 in order to obtain information to synchronize the mobile communication device 110 (e.g., the RF chain 230) to the frequency and timing of the first BTS 122. But the control unit 210 may subsequently determine to postpone BCCH decoding. For example, the control unit 210 may postpone BCCH decoding on the first subscription 142 in order to perform an activity on the second subscription 144. When the control unit 210 returns to decode BCCH data on the first subscription 142, the control unit 210 may decode FCCH and SCH data again on the first subscription 142 if BCCH decoding on the first subscription 142 fails.

In various embodiments, the control unit 210 may determine a cause of the failure to decode BCCH data on the first subscription 142. The control unit 210 may selectively repeat FCCH and SCH decoding on the first subscription 142 based on the cause of the BCCH decoding failure. For example, the control unit 210 may repeat FCCH and SCH decoding on the first subscription 142 if the control unit 210 determines that the cause of the BCCH decoding failure is stale synchronization information. Alternately, the control unit 210 may not repeat FCCH and SCH decoding if the BCCH decoding failure is determined to be due to another cause including, for example, but not limited to, low signal strength from the first BTS 122. If the control unit 210 determines that the BCCH decoding failure is not caused by stale synchronization information, the control unit 210 may attempt to acquire the first communication network 120 on the first subscription 142 and camp on a different BTS (e.g., the second BTS 124).

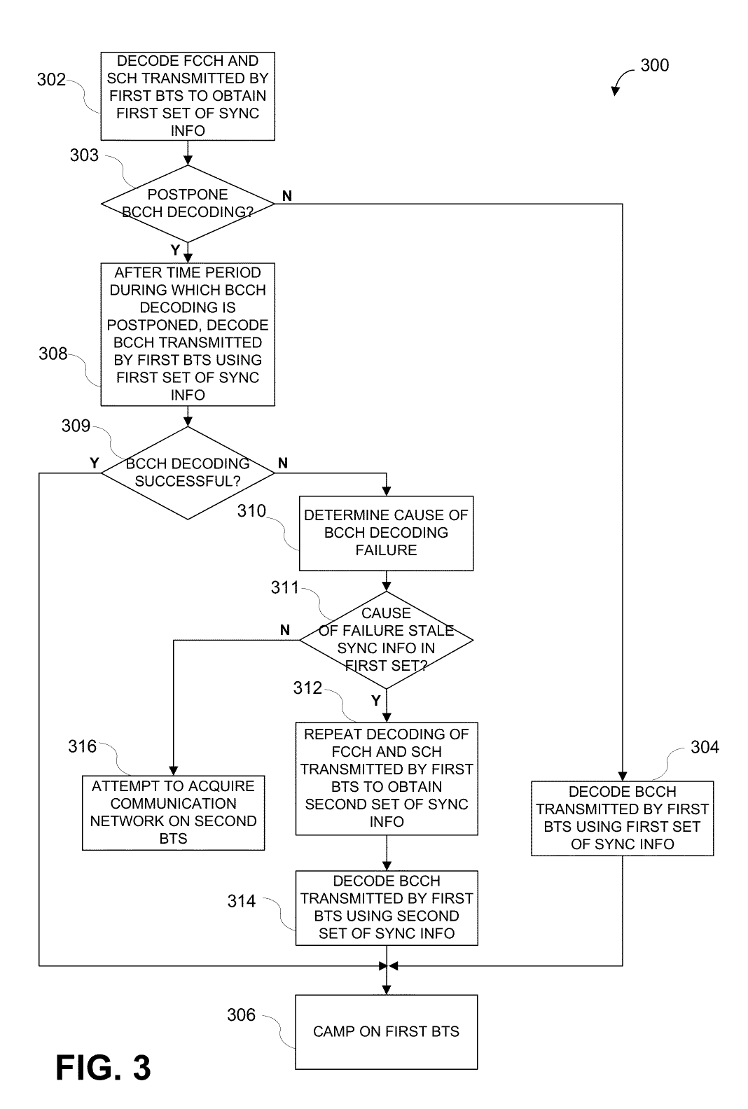

FIG. 3 is a flowchart illustrating a process 300 for optimizing an acquisition of a communication network on a GSM subscription according to various embodiments. With references to FIGS. 1-3, in various embodiments, the process 300 may be performed by the control unit 210, for example, by the decoder module 212.

The control unit 210 may decode FCCH and SCH data transmitted by a first BTS 122 to obtain a first set of synchronization information (302). For example, the control unit 210 may attempt to acquire the first communication network 120 on the first subscription 142 and camp on the first BTS 122. The control unit 210 may decode the FCCH and SCH data broadcast by the first BTS 122 in order to obtain information required to synchronize the mobile communication device 110 (e.g., the RF chain 230) to the frequency and timing of the first BTS 122.

In various embodiments, the control unit 210 may attempt to acquire the first communication network 120 and camp on the first BTS 122 as a result of home PLMN (HPLMN) recovery, PLMN selection, or PLMN search. A person having ordinary skill in the art can appreciate that the control unit 210 may attempt to acquire the first communication network 120 and camp on the first BTS 122 due to other communication network events without departing from the scope of the present inventive concept.

After decoding the FCCH and SCH data broadcast by the first BTS 122, the control unit 210 may determine whether to postpone BCCH decoding (303). In various embodiments, the control unit 210 may determine whether to postpone BCCH decoding on the first subscription 142 based on a priority of a concurrent activity being performed on the second subscription 144. For example, the control unit 210 may detect an activity being performed on the second subscription 144 that has a higher priority than the acquisition of the first communication network 120 on the first subscription 142. In response, the control unit 210 may release the RF chain 230 from the first subscription 142 in order for the second subscription 144 to utilize the RF chain 230 to perform the activity having the higher priority.

The control unit 210 may determine not to postpone BCCH decoding (303-N) and may proceed to decode BCCH data transmitted by the first BTS 122 using the first set of synchronization information (304). The control unit 210 may require the first set of synchronization information in order to decode the BCCH data broadcast by the first BTS 122. Meanwhile, the control unit 210 may not detect an activity having a higher priority being performed on the second subscription 144. Thus, after decoding the FCCH and SCH data broadcast by the first BTS 122 to obtain the first set of synchronization information, the control unit 210 may decode the BCCH data broadcast by the first BTS 122 using the first set of synchronization information. Since BCCH decoding on the first subscription 142 is performed after FCCH and SCH decoding, the first set of synchronization information may have remained current. Consequently, the control unit 210 may successfully decode the BCCH data broadcast by the first BTS 122 using the first set of synchronization information.

The control unit 210 may camp on the first BTS 122 (306). For example, by decoding the BCCH data broadcast by the first BTS 122, the control unit 210 may obtain sufficient information on the identity, configuration, and available features of the first BTS 122 to acquire the first communication network 120 and camp on the first BTS 122.

Alternately, the control unit 210 may determine to postpone BCCH decoding (303-Y). For example, the control unit 210 may determine to postpone BCCH decoding on the first subscription 142 when the control unit 210 detects an activity having a higher priority being performed on the second subscription 144. The control unit 210 may release the RF chain 230 from the first subscription 142, and the second subscription 144 may utilize the RF chain 230 to perform the activity having the higher priority. Accordingly, BCCH decoding on the first subscription 142 may be delayed for a period of time.

After a period of time during which BCCH decoding is postponed, the control unit 210 may decode the BCCH data transmitted by the first BTS 122 using the first set of synchronization information (308). Since BCCH decoding on the first subscription 142 may be postponed for a period of time, at least some of the synchronization information in the first set of synchronization information may become stale during the delay. Consequently, the control unit 210 may fail to decode the BCCH data broadcast by the first BTS 122 using the first set of synchronization information. Thus, the control unit 210 may determine whether the BCCH data broadcast by the first BTS 122 was successfully decoded using the first set of synchronization information (309).

If the control unit 210 determines that the BCCH data broadcast by the first BTS 122 was successfully decoded using the first set of synchronization (309-Y), the control unit 210 may camp on the first BTS 122 (306). For example, the control unit 210 may successfully decode the BCCH data transmitted by the first BTS 122 using the first set of synchronization information. The control unit 210 may obtain sufficient information on the identity, configuration, and capabilities of the first BTS 122 to acquire the first communication network 120 and camp on the first BTS 122.

Alternately, if the control unit 210 determines that the BCCH data broadcast by the first BTS 122 was not successfully decoded using the first set (309-N), the control unit 210 may determine a cause of the BCCH decoding failure (310). The control unit 210 may be configured to determine whether the cause of the BCCH decoding failure is stale synchronization information in the first set of synchronization information (311).

If the control unit 210 determines that the cause of the BCCH decoding failure is not stale synchronization information in the first set of synchronization information (311-N), the control unit 210 may attempt to acquire the first communication network 120 on the second BTS 124 (316).

The BCCH decoding on the first subscription 142 may have failed due to causes other than stale synchronization information in the first set of synchronization information. For example, BCCH decoding may fail due to low signal strength as the mobile communication device 110 travels beyond the coverage area of the first BTS 122. If the BCCH decoding failed not because of stale synchronization information, then the control unit 210 may attempt to acquire the first communication network 120 on a different BTS.

For example, the control unit 210 may attempt to acquire the first communication network 120 on the second BTS 122. The control unit 210 may decode the FCCH and SCH data transmitted by the second BTS 124 to in order to obtain information required to synchronize the mobile communication device 110 (e.g., the RF chain 230) to the frequency and timing of the second BTS 124. The control unit 210 may use the synchronization information to decode the BCCH data transmitted by the second BTS 124 and camp on the second BTS 124

Alternately, if the control unit 210 determines that the cause of the BCCH decoding failure is stale synchronization information in the first set of synchronization information (311-Y), the control unit 210 may repeat decoding of the FCCH and SCH data transmitted by the first BTS 122 to obtain a second set of synchronization information (312). The control unit 210 may decode the BCCH data transmitted by the first BTS 122 using the second set of synchronization information (314) and then camp on the first BTS 122 (306).

Since the second set of synchronization information may be a current set of synchronization information for the first BTS 122, the control unit 210 may successfully decode the BCCH data broadcast by the first BTS 122 using the second set of synchronization information. By successfully decoding the BCCH data broadcast by the first BTS 122, the control unit 210 may obtain sufficient information on the identity, configuration, and capabilities of the first BTS 122 to acquire the first communication network 120 and camp on the first BTS 122.

For clarity and convenience, the process 300 is described with respect to the first subscription 142. However, a person having ordinary skill in the art can appreciate that the control unit 210 may also perform the process 300 with respect to the second subscription 144 instead of or in addition to the first subscription 142 without departing from the scope of the present inventive concept.

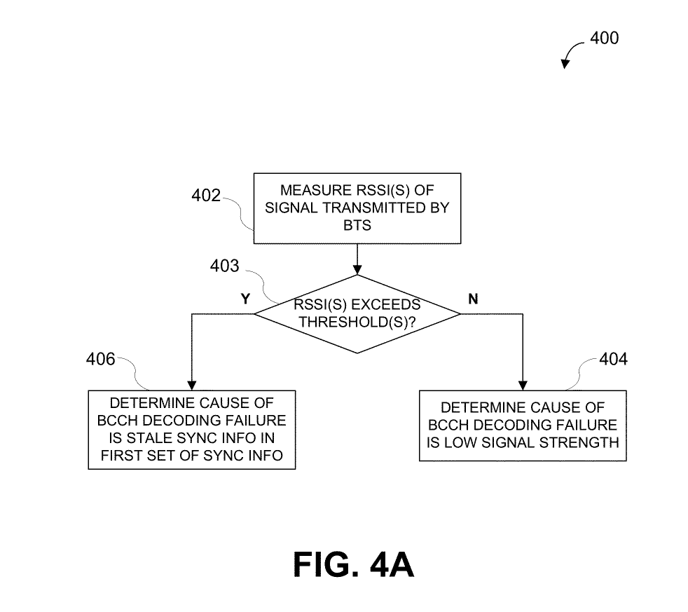

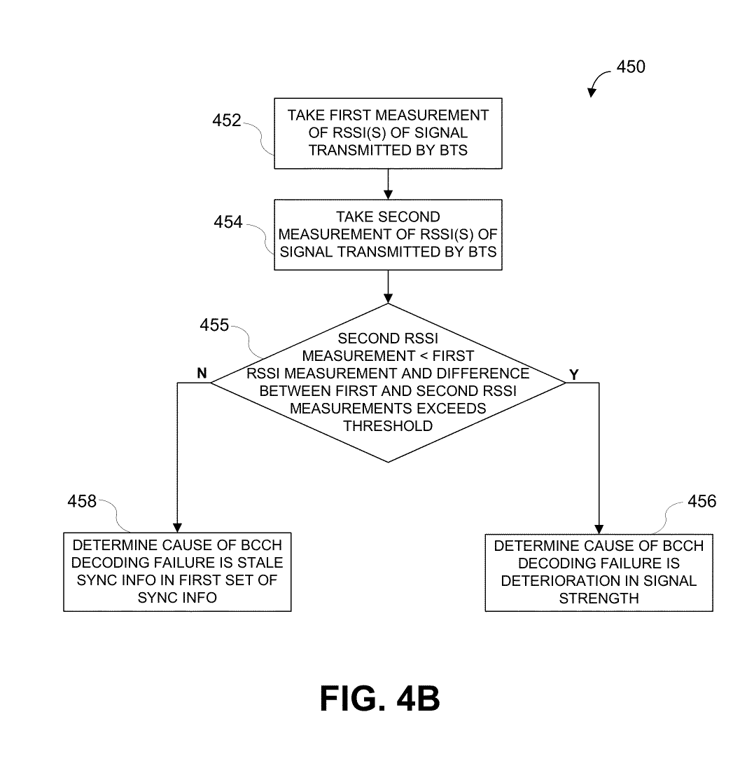

FIG. 4A is a flowchart illustrating a process 400 for determining a cause of BCCH decoding failure according to various embodiments. With reference to FIGS. 1-4A, in various embodiments the process 400 may be performed by the control unit 210, for example, by the causation module 214, and may implement operation 310 of the process 300.

The control unit 210 may measure one or more received signal strength indicators (RSSIs) of a signal transmitted by a BTS (402). For example, the control unit 210 may measure one or more RSSIs of the signal transmitted by the first BTS 122. In various embodiments, the control unit 210 may measure RSSIs after postponing BCCH decoding but prior to decoding the BCCH data broadcast by the first BTS 122. Alternately, the control unit 210 may measure RSSIs during or subsequent to the decoding of the BCCH data broadcast by the first BTS 122.

The one or more RSSIs may include, for example, but not limited to, a received signal level (RxLev) and a received signal quality (RxQual). A person having ordinary skill in the art can appreciate that the control unit 210 may measure other or additional RSSIs without departing from the scope of the present inventive concept. A person having ordinary skill in the art can appreciate that the control unit 210 may measure a signal to noise ratio (SNR) instead of or in addition to RSSIs without departing from the scope of the present inventive concept.

The control unit 210 may determine whether the one or more RSSIs exceed corresponding predetermined thresholds (403). The predetermined threshold for RxLev may be, for example, equal to or less than −90 decibel-milliwatts (dBm) or another threshold value. The predetermined threshold for RxQual may be, for example, a Bit Error Rate (BER) of equal to or greater than 3.2% or another threshold value. Alternatively or additionally, the control unit 210 may determine whether the SNR exceeds a predetermined threshold value.

A failure to decode the BCCH data broadcast by the first BTS 122 may be attributable to poor signal quality and not stale synchronization information. The control unit 210 may determine that the one or more RSSIs do not exceed the corresponding thresholds (403-N). For example, the control unit 210 may determine that the RxLev of the signal from the first BTS 122 is less than or equal to −90 dBm (or other thresholds) and/or that the RxQual of the signal has a BER of equal to or greater than 3.2% (or other thresholds). As a result, the control unit 210 may determine that the cause of the BCCH decoding failure is low signal strength (404).

Alternately, the failure to decode the BCCH data broadcast by the first BTS 122 may be attributable to stale synchronization information for the first BTS 122. For example, the control unit 210 may have decoded the FCCH and SCH broadcast by the first BTS 122 to obtain information to synchronize the mobile communication device 110 to the frequency and timing of the first BTS 122. However, BCCH decoding may have been postponed for a period of time thereafter. As a result, the synchronization information for the first BTS 122 may have become stale during the delay and the control unit 210 may be unable to decode the BCCH data broadcast by the first BTS 122.

The control unit 210 may determine that the one or more RSSIs do exceed the corresponding thresholds (403-Y). For example, the control unit 210 may determine that the RxLev of the signal from the first BTS 122 is greater than −90 dBm (or other thresholds) and/or that the RxQual of the signal has a BER of less than 3.2% (or other thresholds). Accordingly, the control unit 210 may have failed to decode the BCCH data broadcast by the first BTS 122 because the synchronization information became stale during the delay to decode BCCH data. Thus, the control unit 210 may determine that the cause of the BCCH decoding failure is stale synchronization information in the first set of synchronization information (406).

FIG. 4B is a flowchart illustrating a process 450 for determining a cause of BCCH decoding failure according to various embodiments. With reference to FIGS. 1-3 and 4B, in various embodiments the process 400 may be performed by the control unit 210, for example, by the causation module 214, and may implement operation 310 of the process 300.

The control unit 210 may take a first measurement of one or more RSSIs of a signal transmitted by a BTS (452). For example, the control unit 210 may measure one or more RSSIs of the signal from the first BTS 122. In various embodiments, the control unit 210 may take the first measurement of one or more RSSIs before or during the decoding of FCCH and SCH data broadcast by a BTS. Alternately, the control unit 210 may take the first measurement of after FCCH and SCH decoding but before postponing BCCH decoding. For example, the control unit 210 may take the first measurement of one or more RSSIs before, during, or after the decoding of FCCH and SCH data broadcast by the first BTS 122.

The control unit 210 may take a second measurement of the one or more RSSIs of the signal transmitted by the BTS (454). The control unit 210 may take the second measurement of one or more RSSIs before, during, or after the decoding of BCCH data. For example, the control unit 210 may again measure the one or more RSSIs of the signal from the first BTS 122. The control unit 210 may take the second measurement of one or more RSSIs after postponing BCCH decoding but prior to decoding the BCCH data broadcast by the first BTS 122. Alternately, the control unit 210 may take the second measurement of one or more RSSIs during or after the decoding of the BCCH data broadcast by the first BTS 122.

The one or more RSSIs may include, for example, but not limited to, a received signal level (RxLev) and a received signal quality (RxQual). A person having ordinary skill in the art can appreciate that the control unit 210 may measure other or additional RSSIs without departing from the scope of the present inventive concept. Furthermore, a person having ordinary skill in the art can appreciate that the first measurement and the second measurement may be taken of the same or different RSSIs without departing from the scope of the present inventive concept.

The control unit 210 may determine whether the second RSSI measurement is less than the first RSSI measurement, and whether a difference between the first RSSI measurement and the second RSSI measurement exceeds a predetermined threshold (455). When the second RSSI measurement is less than the first RSSI measurement, the difference between the first RSSI measurement and the second RSSI measurement may indicate an extent to which a quality of the signal from the first BTS 122 deteriorated between the two RSSI measurements. For example, the control unit 210 may determine whether the second RSSI measurement is less than the first RSSI measurement, and may compare the difference between the two RSSI measurements to a predetermined threshold in order to assess whether the quality of the signal from the first BTS 122 experienced significant deterioration since postponing BCCH decoding.

If the control unit 210 determines that the second RSSI measurement is less than the first RSSI measurement, and that the difference between the first RSSI measurement and the second RSSI measurement exceeds the predetermined threshold (455-Y), the control unit 210 may determine that the cause of the BCCH decoding failure is deterioration in signal strength (456). The control unit 210 may successfully decode the FCCH and SCH broadcast by the first BTS 122 to obtain synchronization information for the first BTS 122.

While the control unit 210 may postpone BCCH decoding, a subsequent failure to decode the BCCH data may be attributable to a significant deterioration in the quality of the signal from the first BTS 122 and not the synchronization information becoming stale during the delay. For example, the control unit 210 may determine that the BCCH decoding failure is not caused by stale synchronization information when a second RxLev is less than a first RxLev, and a difference between the first and the second RxLev is greater than 10 dBm (or other threshold values). The control unit 210 may also determine that the BCCH decoding did not fail due to stale synchronization information when a BER of the second RxQual is less than a BER of the first RxQual, and a difference between the BER of the first RxQual and the BER of the second RxQual is greater than 0.5% (or other threshold values).

Alternately, the control unit 210 may determine that the second RSSI measurement is not less than the first RSSI measurement, or that the difference between the first RSSI measurement and the second RSSI measurement does not exceed the predetermined threshold (455-N). For example, the control unit 210 may determine that a second RxLev is greater than or equal to a first RxLev, or that a difference between the first RxLev and the second RxLev is less than or equal to 10 dBm (or other thresholds). Alternately, the control unit 210 may determine a BER of the second RxQual is greater than or equal to a BER of the first RxQual, or that a difference between the BER of the first RxQual and the BER of the second RxQual is less than or equal to 0.5% (or other thresholds).

If the second RSSI measurement is not less than the first RSSI measurement or if the difference between the two RSSI measurements does not exceed the predetermined threshold, then the quality of the signal from the first BTS 122 did not experience significant deterioration during the delay to decode the BCCH data broadcast by the first BTS 122. Accordingly, the control unit 210 may determine that the cause of the BCCH decoding failure is stale synchronization information in the first set of synchronization information (458).

For clarity and convenience, the process 450 is described independently of the process 400. However, a person having ordinary skill in the art can appreciate that either or both of the process 400 and the process 450 may implement operation 314 of the process 300.

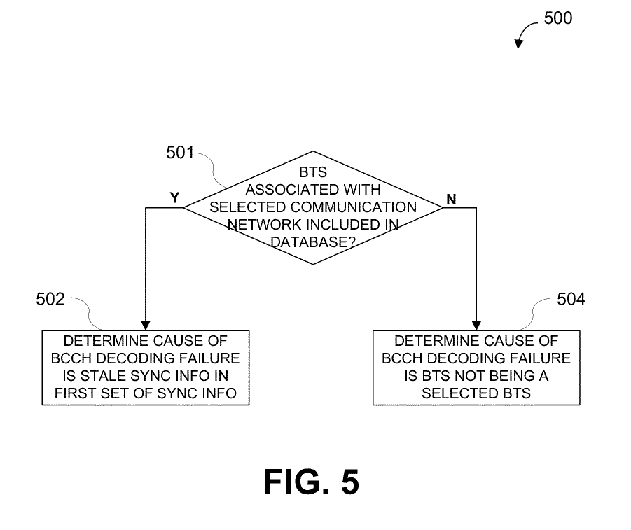

FIG. 5 is a flowchart illustrating a process 500 for determining a cause of BCCH decoding failure according to various embodiments. With reference to FIGS. 1-5, in various embodiments, the process 500 may be performed by the control unit 210, for example, by the causation module 214, and may implement operation 314 of the process 300.

The control unit 210 may determine whether a BTS associated with a selected communication network is included in the database 282 (501). For example, the first communication network 120 may become a selected communication network as a result of manual or automatic communication network selection. On the one hand, manual communication network selection may be performed according to inputs from a user (e.g., via the input unit 272 of the user interface 270) of the mobile communication device 110. Meanwhile, the control unit 210 may perform automatic communication network selection based on the priority of available and accessible communication networks.

The control unit 210 may determine whether the first BTS 122, which is associated with the first communication network 120, is included in the database 282. The database 282 may store the ARFCN of at least one selected BTS on which the control unit 210 has attempted to acquire the first communication network 120. The control unit 210 may determine whether the ARFCN of the first BTS 122 matches one of the ARFCNs stored in the database 282.

If the control unit 210 has already attempted to acquire the first communication network 120 on a particular BTS, then the control unit 210 may have also already decoded the FCCH and SCH data broadcast by that BTS. Thus, if the ARFCN of the first BTS 122 matches one of the ARFCNs stored in the database 282, then the first BTS 122 may have been a selected BTS and the control unit 210 may have already decoded the FCCH and SCH data broadcast by the first BTS 122.

Although the control unit 210 may have already decoded the FCCH and SCH and obtained synchronization information for the first BTS 122, the control unit 210 may nevertheless fail to successfully decode BCCH data broadcast by the first BTS 122. In this case, the failure to decode BCCH data may be attributable to the synchronization information becoming stale during a delay between when FCCH and SCH data from the first BTS 122 was decoded and BCCH decoding. Thus, if the control unit 210 determines that the BTS associated with a selected communication network is included in the database (501-Y), then the control unit 210 may determine that the cause of the BCCH decoding failure is stale synchronization information in the first set of synchronization information (502).

Alternately, the first BTS 122 may not be included in the database 282. For example, the ARFCN of the first BTS 122 may not match one of the ARFCNs stored in the database 282. In this case, the first BTS 122 may not have been a selected BTS and the control unit 210 may have not have already decoded the FCCH and SCH that was broadcast by the first BTS 122 to obtain synchronization information for the first BTS 122. As such, any existing synchronization information may be for a different BTS. Therefore, if the control unit 210 determines that the BTS associated with the selected communication network is not included in the database (501-N), the control unit 210 may determine that the cause of the BCCH decoding failure is the BTS not being a selected BTS (504).

For clarity and convenience, the process 500 is described independently of the process 400 and the process 450. However, a person having ordinary skill in the art can appreciate that any combination of the process 400, process 450, and process 500 may implement operation 314 of the process 300.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non- transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method, comprising:
decoding frequency correction channel (FCCH) data and synchronization channel (SCH) data transmitted by a first base transceiver station (BTS) to obtain a first set of synchronization information;
determining whether broadcast control channel (BCCH) data transmitted by the first BTS was successfully decoded using the first set of synchronization information; and
in response to a determination that the BCCH data transmitted by the first BTS was not successfully decoded using the first set of synchronization information:
determining a cause of a BCCH decoding failure; and
in response to a determination that the cause of the BCCH decoding failure is stale synchronization information in the first set of synchronization information, repeating a decoding of the FCCH data and the SCH data transmitted by the first BTS to obtain a second set of synchronization information.

2. The method of claim 1, further comprising:
determining whether to postpone decoding of the BCCH data transmitted by the first BTS; and
in response to a determination to postpone the decoding of the BCCH data transmitted by the first BTS, decoding the BCCH data transmitted by the first BTS using the first set of synchronization information after a period of time during which the decoding of BCCH data is postponed.

3. The method of claim 2, further comprising determining to postpone the decoding of the BCCH data on a first subscription in response to a detection of a performance of an activity on a second subscription having a higher priority than an acquisition of a communication network on the first subscription.

4. The method of claim 2, wherein a radio frequency (RF) chain is utilized to decode the FCCH, SCH, and BCCH data transmitted by the first BTS in order to acquire a communication network on a first subscription and camp on the first BTS.

5. The method of claim 4, further comprising determining to postpone the decoding of the BCCH data on the first subscription in order to release the RF chain to a second subscription to perform an activity having a higher priority.

6. The method of claim 1, further comprising decoding the BCCH data transmitted by the first BTS using the second set of synchronization information.

7. The method of claim 6, further comprising camping on the first BTS.

8. The method of claim 1, further comprising in response to a determination that the cause of the BCCH decoding failure is not stale synchronization information in the first set of synchronization information, attempting to acquire a communication network on a first subscription on a second BTS.

9. The method of claim 1, wherein determining a cause of the BCCH decoding failure comprises:
measuring at least one receive signal strength indicator (RSSI) of a signal transmitted by the first BTS;
determining whether the at least one RSSI exceeds a predetermined threshold; and
in response to a determination that the at least one RSSI exceeds the predetermined threshold, determining that the cause of the BCCH decoding failure is stale synchronization information in the first set of synchronization information.

10. The method of claim 9, further comprising in response to a determination that the at least one RSSI is equal to or less than the predetermined threshold, determining that the cause of the BCCH decoding failure is low signal strength.

11. The method of claim 1, wherein determining the cause of the BCCH decoding failure comprises:
taking a first measurement of at least one RSSI of a signal transmitted by the first BTS;
taking a second measurement of the at least one RSSI of the signal transmitted by the first BTS;
determining whether a difference between the first RSSI measurement and the second RSSI measurement exceeds a predetermined threshold; and
in response to a determination that the difference between the first RSSI measurement and the second RSSI measurement exceeds the predetermined threshold, determining that the cause of the BCCH decoding failure is stale synchronization information in the first set of synchronization information.

12. The method of claim 11, further comprising in response to a determination that the difference between the first RSSI measurement and the second RSSI measurement is equal to or less than the predetermined threshold, determining that the cause of the BCCH decoding failure is deterioration in signal strength.

13. The method of claim 1, wherein determining the cause of the BCCH decoding failure comprises:
determining whether the first BTS associated with a selected communication network is included in a database; and
in response to a determination that the first BTS is included in the database, determining that the cause of the BCCH decoding failure is stale synchronization information in the first set of synchronization information.

14. The method of claim 13, further comprising in response to a determination that the first BTS is not included in the database, determining that the cause of the BCCH decoding failure is the first BTS not being a selected BTS.

15. The method of claim 13, wherein the database includes an absolute radio frequency channel number (ARFCN) of at least one selected BTS on which an acquisition of a communication network was attempted.

16. A mobile communication device, comprising:
a radio frequency (RF) chain; and
a control unit configured to:
decode frequency correction channel (FCCH) data and synchronization channel (SCH) data transmitted by a first base transceiver station (BTS) to obtain a first set of synchronization information;
determine whether broadcast control channel (BCCH) data transmitted by the first BTS was successfully decoded using the first set of synchronization information; and
in response to a determination that the BCCH data transmitted by the first BTS was not successfully decoded using the first set of synchronization information:
determine a cause of a BCCH decoding failure; and
in response to a determination that the cause of the BCCH decoding failure is stale synchronization information in the first set of synchronization information, repeat a decoding of frequency correction channel (FCCH) data and synchronization channel (SCH) data transmitted by the first BTS to obtain a second set of synchronization information.

17. The mobile communication device of claim 16, wherein the control unit is further configured to:
determine whether to postpone decoding of the BCCH data transmitted by the first BTS; and
in response to a determination to postpone the decoding of the BCCH data transmitted by the first BTS, decode the BCCH data transmitted by the first BTS using the first set of synchronization information after a period of time during which the decoding of BCCH data is postponed.

18. The mobile communication device of claim 17, wherein the control unit is configured to determine to postpone the decoding of the BCCH data on a first subscription in response to a detection of a performance of an activity on a second subscription having a higher priority than an acquisition of a communication network on the first subscription.

19. The mobile communication device of claim 17, wherein the control unit is configured to utilize the RF chain to decode the FCCH, SCH, and BCCH data transmitted by the first BTS in order to acquire a communication network on a first subscription and camp on the first BTS.

20. The mobile communication device of claim 19, wherein the control unit is configured to determine to postpone the decoding of the BCCH data on the first subscription in order to release the RF chain to a second subscription to perform an activity having a higher priority.

21. The mobile communication device of claim 16, wherein the control unit is further configured to decode the BCCH data transmitted by the first BTS using the second set of synchronization information.

22. The mobile communication device of claim 21, wherein the control unit is further configured to camp on the first BTS.

23. The mobile communication device of claim 16, wherein in response to a determination that the cause of the BCCH decoding failure is not stale synchronization information in the first set of synchronization information, the control unit is configured to attempt to acquire a communication network on a first subscription on a second BTS.

24. The mobile communication device of claim 16, wherein to determine the cause of the BCCH decoding failure, the control unit is configured to:
measure at least one receive signal strength indicator (RSSI) of a signal transmitted by the first BTS;
determine whether the at least one RSSI exceeds a predetermined threshold; and
in response to a determination that the at least one RSSI exceeds the predetermined threshold, determine that the cause of the BCCH decoding failure is stale synchronization information in the first set of synchronization information.

25. The mobile communication device of claim 24, wherein in response to a determination that the at least one RSSI does is equal to or less than the predetermined threshold, the control unit is configured to determine that the cause of the BCCH decoding failure is low signal strength.

26. The mobile communication device of claim 16, wherein to determine the cause of the BCCH decoding failure, the control unit is configured to:
take a first measurement of at least one RSSI of a signal transmitted by the first BTS;
take a second measurement of the at least one RSSI of the signal transmitted by the first BTS;
determine whether a difference between the first RSSI measurement and the second RSSI measurement exceeds a predetermined threshold; and
in response to a determination that the difference between the first RSSI measurement and the second RSSI measurement exceeds the predetermined threshold, determine that the cause of the BCCH decoding failure is stale synchronization information in the first set of synchronization information.

27. The mobile communication device of claim 26, wherein in response to a determination that the difference between the first RSSI measurement and the second RSSI measurement is equal to or less than the predetermined threshold, the control unit is configured to determine that the cause of the BCCH decoding failure is deterioration in signal strength.

28. The mobile communication device of claim 16, wherein to determine the cause of the BCCH decoding failure, the control unit is configured to:
determine whether the first BTS associated with a selected communication network is included in a database; and
in response to a determination that the first BTS is included in the database, determine that the cause of the BCCH decoding failure is stale synchronization information in the first set of synchronization information.

29. The mobile communication device of claim 28, wherein the control unit is further configured to:
in response to a determination that the first BTS is not included in the database, determine that the cause of the BCCH decoding failure is the first BTS not being a selected BTS.

30. The mobile communication device of claim 28, wherein the database includes an absolute radio frequency channel number (ARFCN) of at least one selected BTS on which an acquisition of a communication network was attempted.
